(19) United States
(12) Patent Application Publication
(10) Pub. No.: US 2014/0287682 A1
(43) Pub. Date: Sep. 25, 2014

(54) COMMUNICATION DEVICE AND COMMUNICATION METHOD

(71) Applicant: Kabushiki Kaisha Toshiba, Tokyo (JP)

(72) Inventors: Takashi Minemura, Ome-shi (JP); Tadahiro Aihara, Hamura-shi (JP); Toshiyuki Kito, Kodaira-shi (JP)

(73) Assignee: Kabushiki Kaisha Toshiba, Tokyo (JP)

(21) Appl. No.: 14/178,122

(22) Filed: Feb. 11, 2014

Related U.S. Application Data
(63) Continuation of application No. PCT/JP2013/058649, filed on Mar. 25, 2013.

(30) Foreign Application Priority Data
Mar. 25, 2013 (JP) 2013-016105

(51) Int. Cl. H04W 88/10; H04W 4/00

(52) U.S. Cl. CPC H04W 88/10; H04W 4/008
USPC 455/41.1; 455/73

(57) ABSTRACT

According to one embodiment, a communication device includes a single communication module and a controller. The single communication module operates in a first mode or a second mode. The first mode corresponds to near-field wireless communication. The second mode corresponds to wireless communication performed in a longer communication distance than a communication distance at which the near-field wireless communication is performed. The controller causes the communication device to intermittently perform wireless transmission or reception in the first mode or in the second mode, causes the communication device to intermittently perform wireless reception in the second mode at a period based on information repeatedly informed by an external device at a predetermined period, and causes the communication device to intermittently perform, while being synchronized with an operation timing of the second mode, wireless transmission or reception in the first mode during when wireless reception in the second mode is not performed.

### CROSS-REFERENCE TO RELATED APPLICATIONS

This application is a continuation of International application No. PCT/JP2013/058649 filed Mar. 25, 2013, which designates the United States, incorporated herein by reference, and which is based upon and claims the benefit of priority from Japanese Patent Application No. 2013-016105, filed Jan. 30, 2013, the entire contents of which are incorporated herein by reference.

### FIELD

Embodiments described herein relate generally to a communication device and a communication method.

### BACKGROUND

Conventionally, some home appliances such as a refrigerator, a television, and an electric rice cooker have a communication function to communicate with mobile information terminals such as a smartphone and a tablet by proximity wireless communication such as near-field communication (NFC). When a user brings a mobile information terminal into close proximity to a home appliance to perform a touch operation, and the distance between the home appliance and the mobile information terminal is within a communication range of near-field wireless communication, the home appliance and the mobile information terminal transmit and receive information by near-field wireless communication.

The above described conventional technique requires implementation of a communication module for near-field communication in addition to a communication module of wireless local area networks (LANs) in which normal wireless communication is performed, thereby increasing both cost and implementation space. Furthermore, the user cannot enjoy, by only using wireless LANs in which normal wireless communication is performed, the utility of near-field communication: information can be transmitted and received between a mobile information terminal and a home appliance only when the user performs an intuitive operation such as the touch operation in which the user brings the mobile information terminal into close proximity to the home appliance.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram exemplifying a configuration of a communication device according to an embodiment;

FIG. 2 is an exemplary block diagram exemplifying a configuration of the communication device in the embodiment;

FIG. 3 is an exemplary diagram exemplifying intermittent wireless communication performed by a wireless communication module, in the embodiment;

FIG. 4 is an exemplary diagram illustrating one example of asynchronous wireless communication;

FIG. 5 is an exemplary diagram exemplifying intermittent wireless communication performed by the wireless communication module, in the embodiment;

FIG. 6 is an exemplary diagram exemplifying intermittent wireless communication performed by the wireless communication module, in the embodiment;

FIG. 7 is an exemplary diagram exemplifying intermittent wireless communication performed by the wireless communication module, in the embodiment;

FIG. 8 is an exemplary ladder chart exemplifying wireless communication between communication devices, in the embodiment;

FIG. 9 is an exemplary flowchart illustrating one example of the operation of the communication device, in the embodiment; and

FIG. 10 is an exemplary flowchart illustrating one example of the operation of the communication device, in the embodiment.

### DETAILED DESCRIPTION

In general, according to one embodiment, a communication device comprises a single communication module and a controller. The single communication module is configured to operate in a first mode or a second mode. The first mode corresponds to near-field wireless communication. The second mode corresponds to wireless communication configured to be performed in a longer communication distance than a communication distance at which the near-field wireless communication is performed. The controller is configured to cause the communication device to intermittently perform wireless transmission or reception in the first mode or in the second mode, to cause the communication device to intermittently perform wireless reception in the second mode at a period based on information repeatedly informed by an external device at a predetermined period, and to cause the communication device to intermittently perform, while being synchronized with an operation timing of the second mode, wireless transmission or reception in the first mode during when wireless reception in the second mode is not performed.

Following is a detailed description of a communication device and a communication method according to an embodiment with reference to the accompanying drawings.

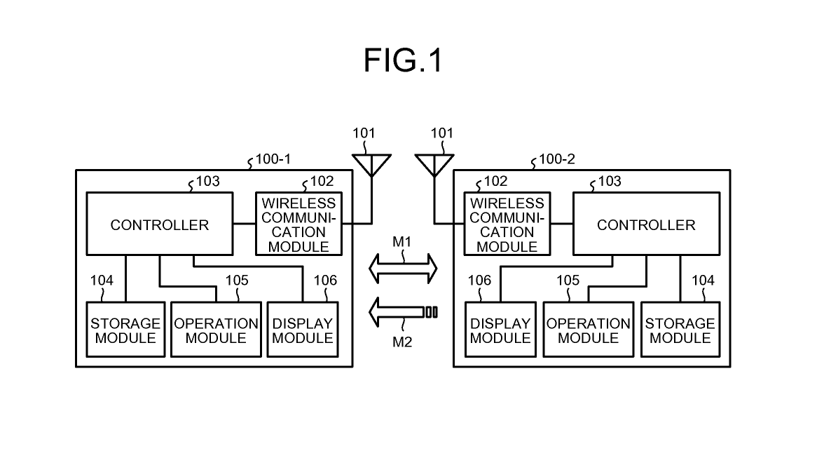

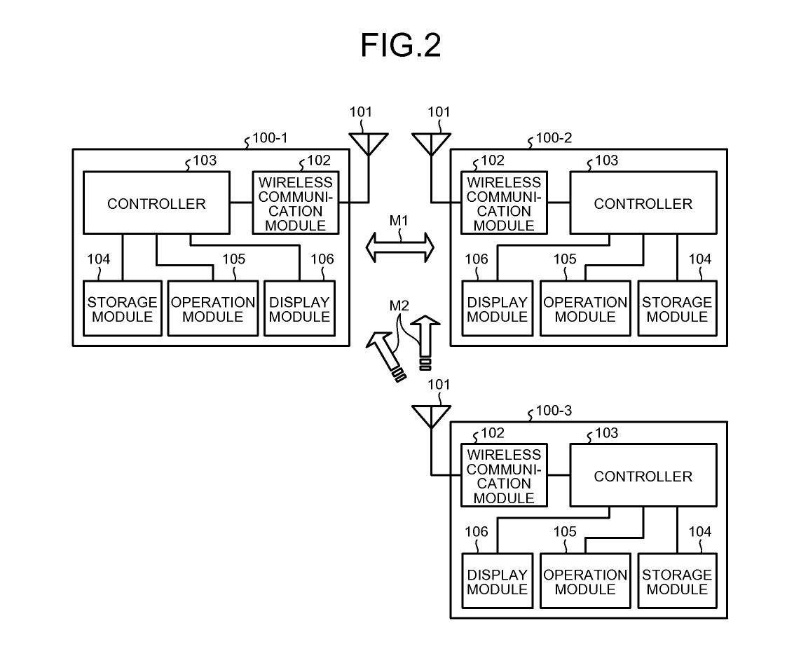

FIGS. 1 and 2 are block diagrams each exemplifying a configuration of the communication device in the embodiment. Specifically, FIG. 1 is a block diagram exemplifying configurations of communication devices 100-1 and 100-2, and FIG. 2 is a block diagram obtained by adding a configuration of a communication device 100-3 to the configurations in FIG. 1.

As illustrated in FIGS. 1 and 2, the communication devices 100-1, 100-2, and 100-3 each comprise a wireless communication module 102 that is a wireless communication module performing wireless communication via an antenna 101, and a controller 103 that controls the operation of the wireless communication module 102. The communication devices 100-1, 100-2, and 100-3 can wirelessly communicate with one another when the distance between the devices is within a communication range of the wireless communication modules 102. Examples of the communication devices 100-1, 100-2, and 100-3 are a home appliance such as a refrigerator, a television, or an electric rice cooker; a mobile information terminal such as a smartphone or a tablet; and an access point (AP) that connects the home appliance and the mobile information terminal to a communication network such as the Internet. In the present embodiment, assume that the communication device 100-1 is a mobile information terminal, the communication device 100-2 is a home appliance, and the communication device 100-3 is an AP.

The wireless communication module 102 operates, under the control of the controller 103, in a first communication mode M1 in which near-field wireless communication (transmission or reception) is performed within a communication range of a few centimeters to about one meter, or in a second communication mode M2 in which wireless communication (transmission or reception) is performed within a communication range of 10 m to 100 m as the upper limit of wireless LANs based on IEEE 802.11 standards. The wireless communication module 102 is, for example, a single wireless LAN chip and switches the communication modes in accordance with the control of the controller 103. Specifically, in the first communication mode M1, voltage (gain) applied in transmission or reception such as reception sensitivity or transmission output (power) is controlled so that the communication range is regulated within a few centimeters to about one meter. In the second communication mode M2, the voltage (gain) applied in transmission or reception such as the reception sensitivity or the transmission output (power) is controlled so that the communication range is regulated within 10 m to 100 m as the upper limit. It should be noted that near-field wireless communication may only refer to wireless communication performed within a communication range with the upper limit being smaller than that of the communication range of the second communication mode M2, and may be wireless communication performed within a communication range of a few centimeters to about one meter that is assumed in NFC, for example. Wireless communication modules in FIGS. 1 and 2 use the same wireless communication method and can detect same broadcast information.

Thus, when the communication devices 100-1 and 100-2 are in the communication range of the second communication mode M2 such as in a house, wireless communication using wireless LANs is performed in the second communication mode M2. When a user performs a touch operation, in which the user brings the communication device 100-1 into close proximity to the communication device 100-2, the communication devices 100-1 and 100-2 enter the communication range of the first communication mode M1, and thus near-field wireless communication is performed in the first communication mode M1.

There are two types of networks in a wireless LAN in the second communication mode M2. One is an ad hoc network in which the AP does not exist as illustrated in FIG. 1 and the communication devices 100-1 and 100-2 connect with each other in an ad hoc manner. The other one is an infrastructure network in which the communication device 100-3 as the AP exists as illustrated in FIG. 2 and that is configured by the communication devices 100-1 and 100-2 as terminals (stations [STAs]) and the AP. In a conventional concept, when the infrastructure network is formed, the AP and the STAs form a parent-child relation. Here, the AP recognizes which STAs belong to the AP by receiving responses from the STAs to a beacon signal broadcast periodically by the AP. In the present embodiment, however, such a conventional infrastructure network may not be necessarily formed. This is because the STAs in the present embodiment may only collect timing information for synchronization by receiving the beacon signal from the AP unidirectionally, and the STAs do not need to transmit a response to the AP to establish communication therewith. Thus, the AP in the present embodiment does not need to know the presence of the STAs. Accordingly, the second communication mode M2 may be a mode in which the STAs receive the beacon signal of the AP only to obtain synchronization information without forming the parent-child relation with the AP. When the ad hoc network is formed in the conventional concept, the beacon signal is transmitted and received between the STAs that communicate with each other, so that the STAs know the presence of each other and obtain the timing information for synchronization as necessary. Thus, when the STAs cannot exchange information of the beacon signal in such a case in which the distance therebetween is too far to communicate, the STAs cannot synchronize with each other.

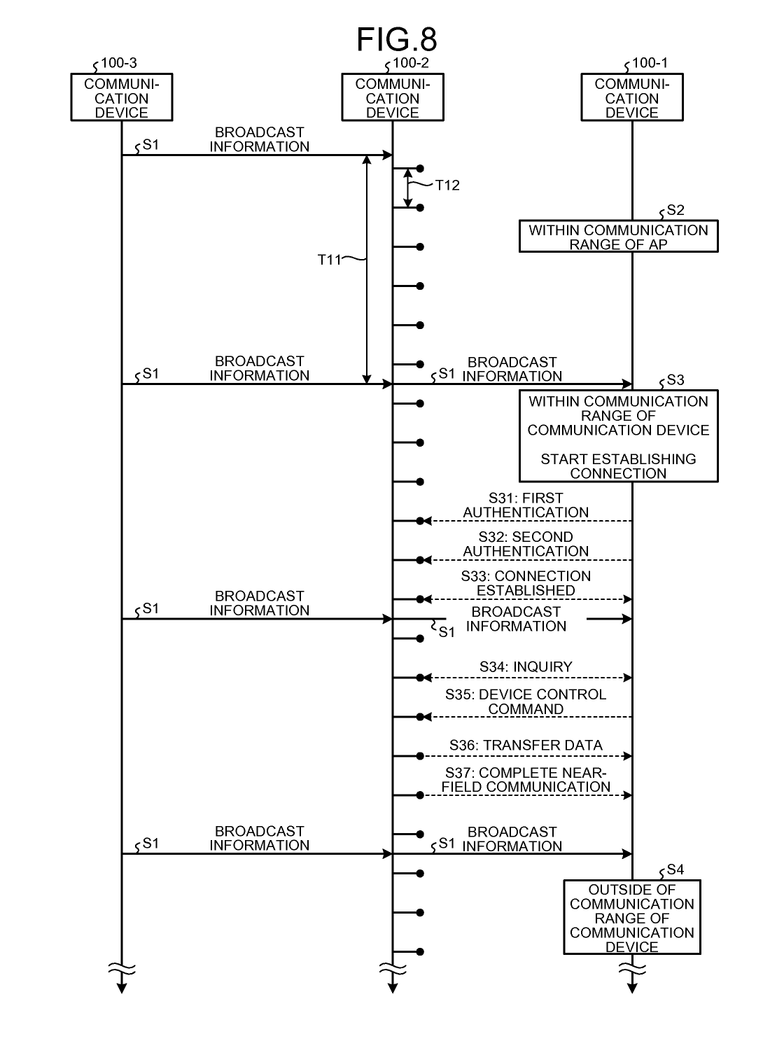

In the infrastructure network, the AP serves as a timing master, and notifies the STAs of a timer value obtained by a timing synchronization function (TSF) by broadcasting the timer value as the beacon signal (packet) (see broadcast information in FIG. 8, for example). The TSF is a function to fulfill timing synchronization. The STAs correct their own timer values to the value thus broadcasted. In the ad hoc network, broadcast information such as the beacon signal (packet) received between the STAs is used for the STAs to synchronize time with each other. For example, when the communication device 100-2 broadcasts a beacon signal, the communication device 100-1 receives the beacon signal from the communication device 100-2 to synchronize with the communication device 100-2. To summarize, in the second communication mode M2, synchronous communication is performed in which broadcast information is used to synchronize the communication devices with each other. In this case, as described above, although the STAs can collect timing information from the beacon signal broadcast by the AP, the infrastructure network is not formed unless the STAs respond to an inquiry of the beacon signal from the AP.

The controller 103 comprises a central processing unit (CPU), a random access memory (RAM), and a read only memory (ROM). The controller 103 controls the communication device such that the CPU loads programs stored in the ROM into the RAM and sequentially executes them. The controller 103 comprises a counting module such as a crystal oscillator, and controls the operation of each module in, for example, milliseconds (ms). Specifically, the controller 103 causes the wireless communication module 102 to intermittently perform wireless communication in the first communication mode M1 and the second communication mode M2 by switching the wireless communication modes in milliseconds in synchronization with the above described broadcast information.

The communication devices 100-1, 100-2 and 100-3 may comprise a storage module 104, an operation module 105, and a display module 106. The storage module 104 comprises a non-volatile memory that stores various types of setting information used for the control by the controller 103. The operation module 105 comprises an operation key and/or a touch panel that receives operation by a user. The display module 106 comprises a liquid crystal display that performs screen display under the control of the controller 103.

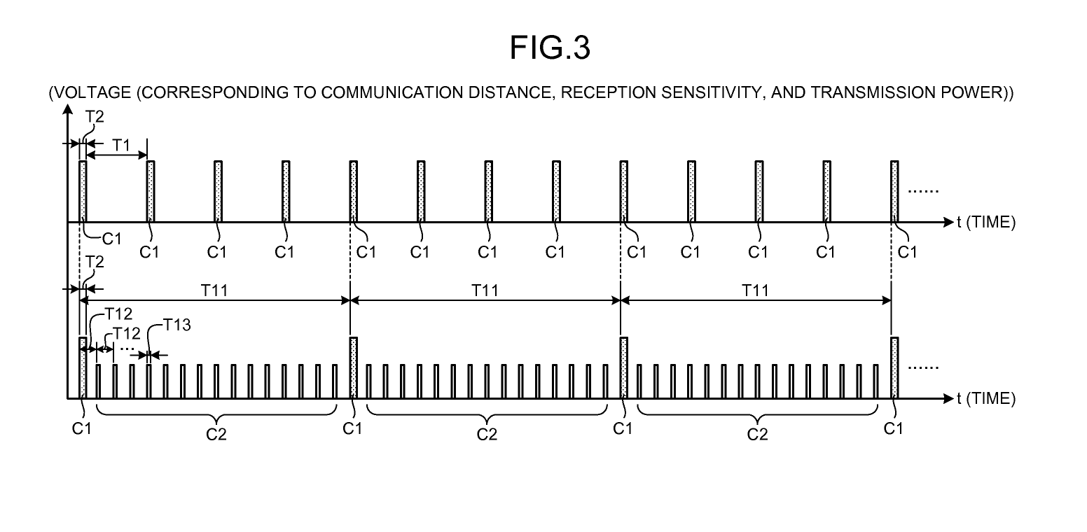

Described here is intermittent wireless communication performed by the wireless communication module 102 under the control of the controller 103. FIG. 3 is a diagram exemplifying the intermittent wireless communication performed by the wireless communication module 102. Specifically, the axis extending in the right direction represents time, and the axis in the vertical direction represents voltage applied in transmission and reception in the wireless communication module 102. The timing of synchronous communication C1 performed by the AP (communication device 100-3) is illustrated in the upper row, and the timing of the synchronous communication C1 in the second communication mode M2, and the timing of synchronous communication C2 in the first communication mode M1 performed by the STAs (communication devices 100-1 and 100-2) are illustrated in the lower row.

As illustrated in FIG. 3, the AP performs broadcast (broadcast transmission) of the beacon signal that is the timer value in the TSF under the control of the controller 103 in the synchronous communication C1 that is performed at a predetermined period T1 and continues for a predetermined communication time T2. The period T1 has a value set in advance of, for example, about 100 ms. The communication time T2 has a value set in advance of, for example, about a few milliseconds. The period T1 and the communication time T2 are counted precisely by the crystal oscillator and the like in the AP. In the broadcast in the communication period C1 of the AP, a service set identifier (SSID) that identifies the AP is also delivered.

The STAs intermittently perform detection operation of the beacon signal (stand by for [perform wireless reception of] the beacon signal) in the second communication mode M2 under the control of the controller 103 at an period T11 based on the beacon signal (broadcast information) received in the synchronous communication C1 with the AP. Specifically, the controller 103 causes the wireless communication module 102 to intermittently wake up in the second communication mode M2 at the period T11 obtained by an integral multiple (four times in the example of FIG. 3) of the period T1, during which the AP broadcasts the beacon signal, for the communication time T2. The controller 103 corrects the period T11 based on the beacon signal received by the AP in the synchronous communication C1. Specifically, the controller 103 in the STAs corrects the period T11 before the next intermittent wake-up in a manner in which the timing counted by the crystal oscillator and the like is set to coincide with the timing based on the beacon signal. At this time, the controller 103 may be configured not to transmit a response signal to the beacon signal received from the AP in the synchronous communication C1. In a case in which the STAs do not transmit a response signal to the beacon signal from the AP, the STAs do not need to respond at a delivery traffic indication massage (DTIM) period, and thus the STAs can stand by with their power consumption low.

The STAs cause, under the control of the controller 103, the wireless communication module 102 to intermittently wake up in the first communication mode M1 in synchronization with the execution timing in the second communication mode M2 in an interval during which wireless communication is not performed in the second communication mode M2. Specifically, the controller 103 controls the wireless communication module 102 to intermittently wake up in the first communication mode M1 from the start of the synchronous communication C1 in the second communication mode M2 at a period T12 for a communication time T13. Thereby, the STAs in the communication range of the first communication mode M1 perform the synchronous communication C2 in a near field. Here, the period T12 and the communication time T13 may be set to any value in advance. For example, the period T12 may be set to a value of about a few milliseconds to several tens milliseconds. The communication time T13 may be set to a value of about 1 ms. During the intermittent wake-up time, a STA transmits a communication request to the other STA, or receives a communication request (detects a communication request) from the other STA. When paring with the other STA is completed, the STA starts communicating with the other STA. After the completion of the pairing, the STA may communicate with the other STA in the communication range of the first communication mode or in the second communication mode. The STA, when completing transmission and reception of the communication request and the response thereof, may also shift from an intermittent wake-up state in which stand-by and sleep are repeated to a normal stand-by state in which the stand-by state is maintained, and then starts communication. Although the STA performs transmission or reception in the intermittent wake-up time in accordance with, for example, a user setting, the STA may be controlled to perform transmission only in a case in which a user setting is received, and may be controlled to perform reception in other cases.

The STAs can, therefore, perform the synchronous communication C2 in a near field without implementing a communication module for near-field communication in addition to the wireless communication module 102 that is a communication module for communication in a wireless LAN, in other words, without increasing both cost and implementation space. Moreover, the utility of the near-field communication can be obtained: information can be transmitted and received between the STAs only when a user performs an intuitional operation such as the touch operation, in which the user brings the communication device 100-1 into close proximity to the communication device 100-2.

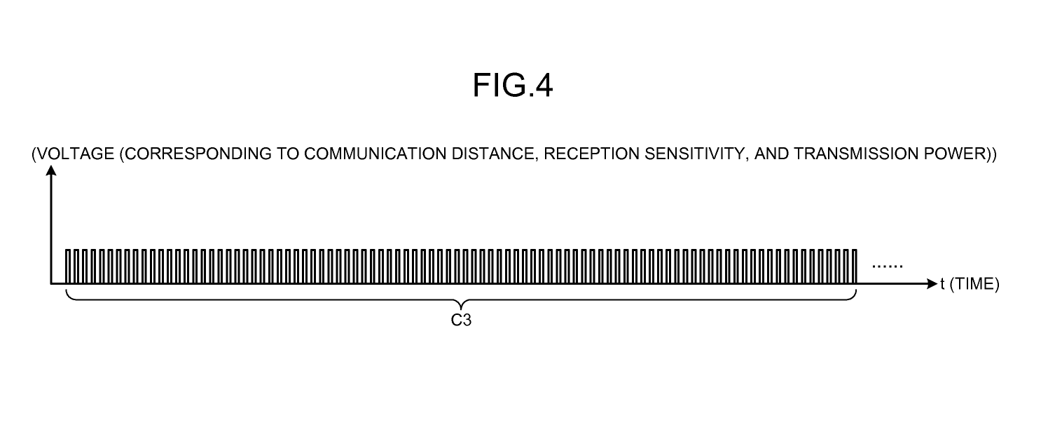

FIG. 4 is a diagram illustrating an example of asynchronous wireless communication. As illustrated in FIG. 4, in asynchronous communication C3, dense intermittent wake-ups are required so that the STAs can communicate with each other when they are brought into close proximity. However, dense intermittent wake-ups are not required in the synchronous communication C2 in the first communication mode M1 performed in synchronization with the execution timing in the second communication mode M2, thereby suppressing power consumption as is clear from the comparison of FIGS. 3 and 4 (comparison of the area of the synchronous communication C2 and that of the asynchronous communication C3).

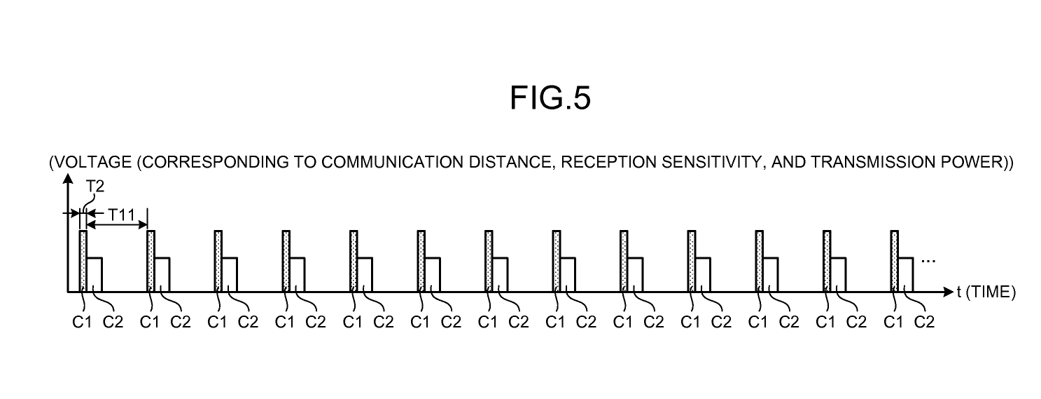

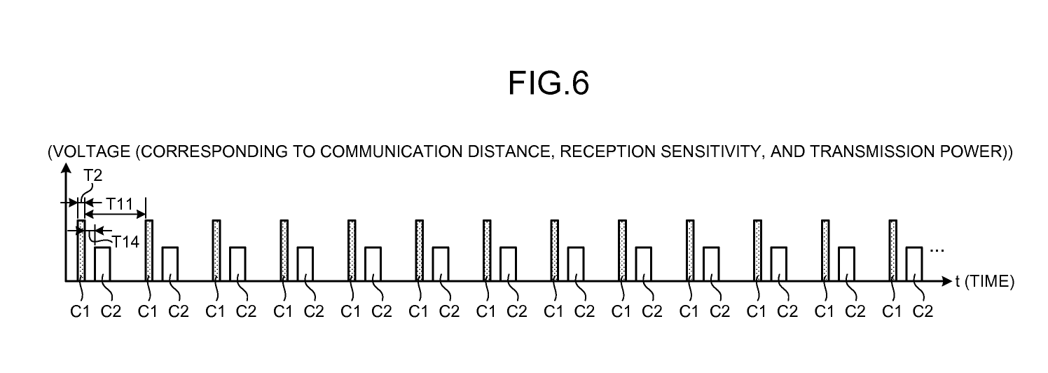

It should be noted that the timing of the synchronous communication C2 in the first communication mode M1 may be any timing as long as it synchronizes with the execution timing in the second communication mode M2. FIGS. 5 and 6 are diagrams exemplifying intermittent wireless communication performed by the wireless communication module 102. For example, as illustrated in FIG. 5, the synchronous communication C2 in the first communication mode M1 may be performed immediately after the completion of the synchronous communication C1 in the second communication mode M2. As illustrated in FIG. 6, the synchronous communication C2 in the first communication mode M1 may be performed after a time interval T14 has passed from the completion of the synchronous communication C1 in the second communication mode M2.

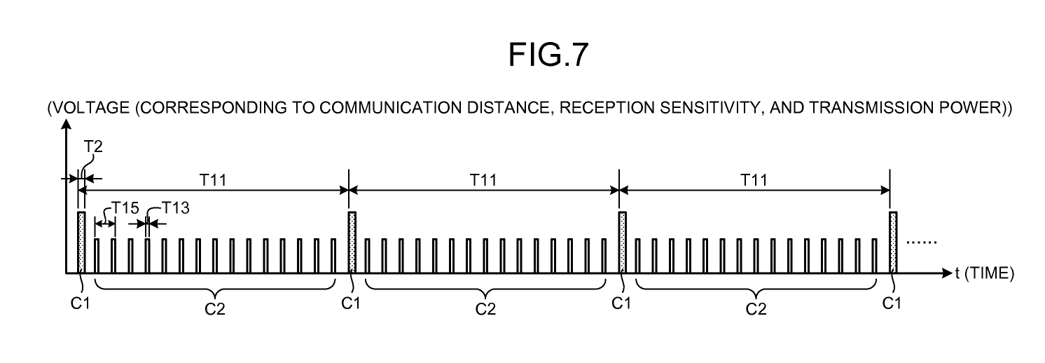

The wireless communication module 102 may be provided with a condition regarding authentication time before starting a communication session. The condition is that, when the wireless communication module 102 performs at least two times of near-field wireless communication with an external device (STA) in the synchronous communication C2 in the first communication mode M1, the wireless communication module 102 can establish near-field wireless communication with the STA. FIG. 7 is a diagram that exemplifies intermittent wireless communication performed by the wireless communication module 102, and that exemplifies a time period T15 required to start a communication session. The time period T15 comprising at least two times of the synchronous communication C2 as illustrated in FIG. 7 is set in advance as setting information stored in the storage module 104. The wireless communication module 102 starts a communication session with an STA with which near-field wireless communication in the synchronous communication C2 has been performed such consecutive times in the time period T15. In this manner, starting a communication session with an STA with which near-field wireless communication in the synchronous communication C2 has been performed a plurality of times can prevent a case from occurring in which a communication session is started by accidental communication from a long distance outside the communication range.

FIG. 8 is a ladder chart exemplifying wireless communication between the communication devices. As illustrated in FIG. 8, the beacon signal (broadcast information) comprising a timer value in the TSF is notified at the period T11 by the communication device 100-3 as the AP (S1). The communication device 100-2 placed in a house performs wireless communication intermittently in the second communication mode M2 at the period T11 on the basis of the beacon signal from the communication device 100-3 to perform synchronous communication with the communication device 100-3. The communication device 100-2 also performs near-field wireless communication intermittently in the first communication mode M1 at the period T12 on the basis of the broadcast information from the communication device 100-3.

Here, assume that a user who carries the communication device 100-1 enters the house, and the communication device 100-1 is brought into a communication range in which the broadcast information of the communication device 100-3 as the AP is broadcast (S2). At this time, the controller 103 of the communication device 100-1 starts, based on the broadcast information from the communication device 100-3, communication in the second communication mode M2 in synchronization with the broadcast information in the same manner as the communication device 100-2 does. The controller 103 of the communication device 100-1 performs near-field wireless communication intermittently in the first communication mode M1 at the period T12 on the basis of the broadcast information from the communication device 100-3.

The controller 103 of the communication devices 100-1 and 100-2 as the STAs may be configured to perform near-field communication in the first communication mode M1 intermittently on the basis of the SSID that identifies the AP when the controller 103 receives the broadcast information that comprises the SSID set in advance in information such as the setting information stored in the storage module 104. In this manner, setting in advance an SSID in the broadcast information that causes near-field wireless communication in the first communication mode M1 can define the place in which near-field wireless communication is performed. For example, assume that the user registers in advance in the communication device 100-1 carried by the user the SSID of the communication device 100-3 as the AP installed in a house. In this case, when the user is in the communication range of the AP installed in the house, the communication device 100-1 can operate in a mode in which near-field wireless communication is performed.

Next, the user performs a touch operation, in which the user brings the communication device 100-1 into close proximity to the communication device 100-2, and, when the communication devices 100-1 and 100-2 enter into a range of near-field wireless communication in the first communication mode M1, processing to establish connection in near-field wireless communication is started (S3).

Specifically, at least two times of the synchronous communication C2 are authenticated (S31 and S32), and the communication devices 100-1 and 100-2 establish communication (S33). Between the communication devices 100-1 and 100-2 that have established communication, inquiries (S34), transmission and reception of device control commands (S35), and transfer of data (S36) are performed, and then, near-field wireless communication is completed (S37).

The controllers 103 of the communication devices 100-1 and 100-2 may store in the storage module 104 a parameter used at establishing near-field wireless communication together with identification information such as a media access control (MAC) address that identifies a device, and may establish communication by referring to the parameter when near-field wireless communication is performed for the second time or later. In this manner, time required to establish communication for the second time or later can be reduced by storing both a parameter used at establishing near-field wireless communication and identification information that identifies a device, and then starting again, as, for example, a persistent mode, near-field wireless communication with reference to the stored parameter and the identification information.

Next, the user moves the communication device 100-1 away from the communication device 100-2, and the communication devices 100-1 and 100-2 become so distant that they are not in the range of near-field wireless communication in the first communication mode M1 (S4).

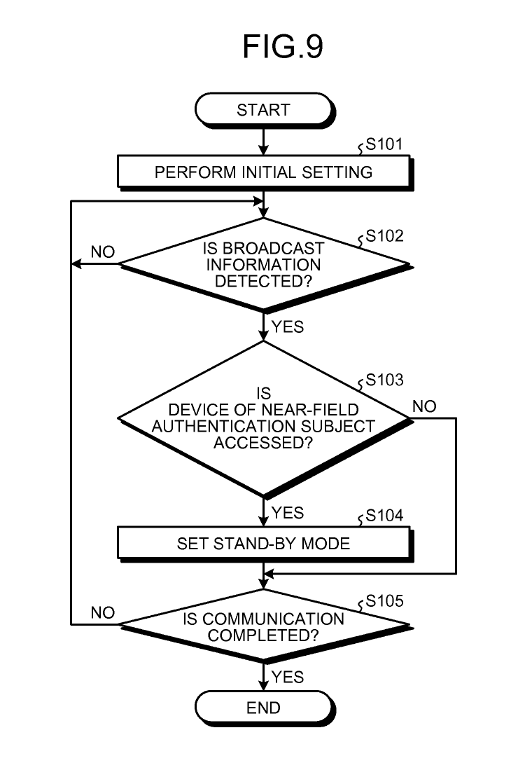

Next, described in detail is the operation of the communication device 100-2 as a stand-by device. FIG. 9 is a flowchart illustrating an example of the operation of the communication device 100-2.

As illustrated in FIG. 9, when processing is started after power is on and the like, the controller 103 performs initial setting on the basis of information such as the setting information stored in the storage module 104 (S101). Examples of the initial setting are correction of a period based on the beacon signal received from the communication device 100-3 by the wireless communication module 102, setting of transmission output and sensitivity for performing near-field wireless communication in the first communication mode M1, checking whether any device is registered as a device with which near-field wireless communication is performed, and checking whether there is a setting for performing intermittent communication in the first communication mode M1.

Next, the controller 103 determines, based on data received by the wireless communication module 102, whether broadcast information is detected that is broadcast by the communication device 100-3 as the AP (S102). When the broadcast information is not detected (No at S102), the process holds.

When the broadcast information is detected (Yes at S102), the controller 103 determines whether a setting by the initial setting is to access a device (STA) of a near-field authentication subject, in other words, to perform intermittent communication in the first communication mode M1 (S103).

When the setting is to perform intermittent communication in the first communication mode M1 (Yes at S103), the controller 103 causes near-field wireless communication in the first communication mode M1 to be performed intermittently on the basis of the broadcast information, and brings the communication device 100-2 into a stand-by mode for near-field wireless communication (S104). When the setting is not to perform intermittent communication in the first communication mode M1 (No at S103), near-field wireless communication in the first communication mode M1 is not performed intermittently, and the communication device 100-2 is not brought into the stand-by mode for near-field wireless communication. The controller 103 then determines whether communication is completed because of the power-off or the like (S105). When communication is not completed, the process returns to S102.

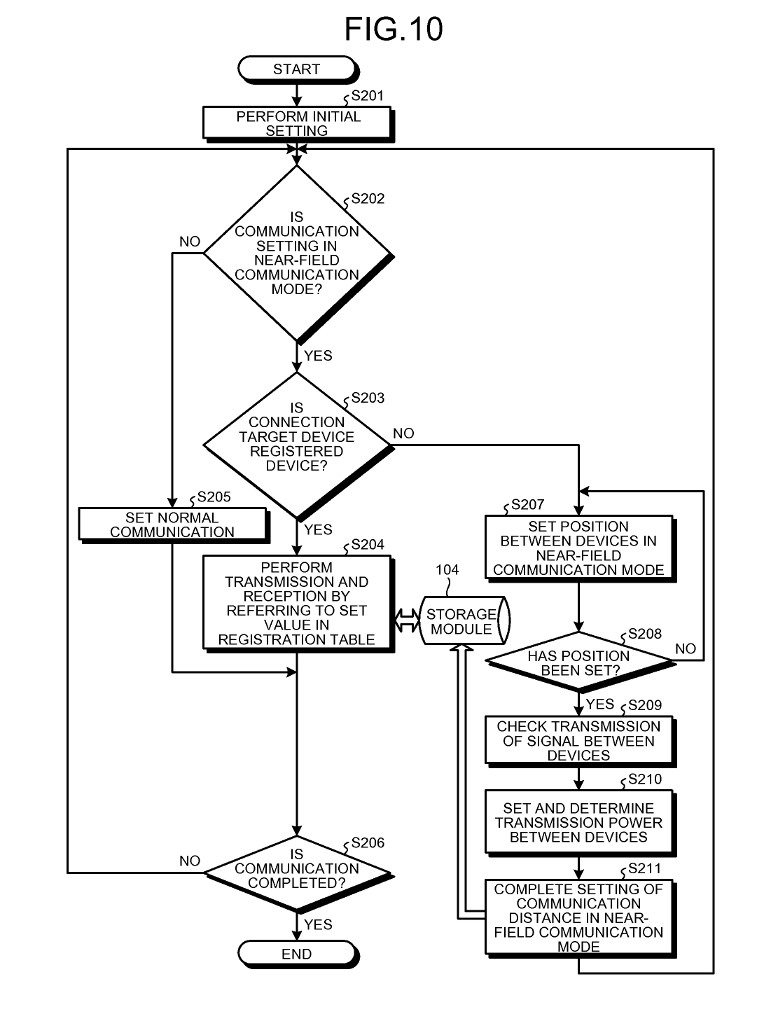

Next, described in detail is the operation of the communication device 100-1 as a device that is carried and operated by a user. FIG. 10 is a flowchart illustrating an example of the operation of the communication device 100-1.

As illustrated in FIG. 10, when processing is started after power is on and the like, the controller 103 performs initial setting based on information such as the setting information stored in the storage module 104 (S201). Examples of the initial setting are correction of a period based on the beacon signal received from the communication device 100-3 by the wireless communication module 102, setting of transmission output and sensitivity for performing near-field wireless communication in the first communication mode M1, checking whether any device is registered as a device with which near-field wireless communication is performed, and checking whether there is a setting for performing intermittent communication in the first communication mode M1.

Next, the controller 103 determines, based on a setting in the initial setting, whether there is a communication setting in a near-field communication mode (the first communication mode M1) (S202). When there is no communication setting in a near-field communication mode (No at S202), normal communication in the second communication mode M2 is set (S205).

When there is a communication setting in a near-field communication mode (Yes at S202), the controller 103 performs the same procedure as that from S102 to S104 described above, and brings the communication device 100-1 into a stand-by mode for near-field wireless communication. Here, assume that the communication device 100-1 is brought, by the touch operation by the user, into a communication range in which near-field wireless communication is performed with the communication device 100-2.

The controller 103 determines whether a connection target device, that is, the communication device 100-2 that enters the communication range in which near-field wireless communication is performed is a registered device (S203). Specifically, the controller 103 performs near-field wireless communication with the communication device 100-2, and acquires information such as a MAC address that identifies the communication device 100-2, and determines whether setting information corresponding to the MAC address is stored in a registration table in the storage module 104. When the communication device 100-2 is a registered device, the controller 103 refers to a set value in the registration table, and sets, on the basis of the set value, transmission output or reception sensitivity in the first communication mode M1 to perform transmission and reception in near-field wireless communication (S204). After S204 and S205, the controller 103 determines whether communication is completed because of the power-off or the like (S206). When communication is not completed (No), the process returns to S202.

When the communication device 100-2 is not the registered device, the controller 103 performs positioning of the devices in the near-field communication mode (first communication mode M1) (S207). Specifically, the controller 103 receives from the operation module 105 a user operation for the positioning such as a push operation of a determination button that is performed when the communication devices 100-1 and 100-2 are positioned in a desired distance from each other.

Next, the controller 103 determines whether the positions have been set by the user's operation for the positioning (S208). When the positions have not been set (No at S208), the process returns to S207 and the controller 103 waits for the user's operation for the positioning.

When the user's operation for the positioning has been performed (Yes at S208), the controller 103 checks transmission of signals between the devices by the wireless communication module 102 (S209), and sets/determines transmission power (output) between the devices, and reception sensitivity (S210). The transmission power (output) and the reception sensitivity in the first communication mode M1 may be set to any value by the user so that the STAs can communicate in a desired distance as described above.

Specifically, in setting/determining transmission output, the controller 103 receives a push operation of the determination button at a desired distance, and gradually increases transmission output in the first communication mode M1 while checking a response from the communication device 100-2 as the corresponding device. When the controller 103 receives a response to the transmission and it is a normal response, the controller 103 determines it as the lowest value of the transmission output and sets the value. At this time, the controller 103 may first transmit to the communication device 100-2 a command that instructs the communication device 100-2 to set the reception sensitivity in the first communication mode M1 to a predetermined value, and then start setting/determining transmission output. In this manner, signal saturation in the first communication mode M1 can be avoided by setting the transmission output.

In addition, in setting/determining reception sensitivity, the controller 103 receives the push operation of the determination button at a desired distance, and gradually increases reception sensitivity in the first communication mode M1 while checking a response from the communication device 100-2 as the corresponding device. When the controller 103 receives a response to the transmission and determines it as a normal reception, the controller 103 determines the reception sensitivity at this time as the lowest value thereof and sets the value. At this time, the controller 103 may first transmit to the communication device 100-2 a command that instructs the communication device 100-2 to set the transmission output in the first communication mode M1 to a predetermined value, and then start setting/determining reception sensitivity. In this manner, a secure communication can be established by setting the reception sensitivity to a value not exceeding what is needed.

Next, the controller 103 stores in the registration table in the storage module 104 the transmission output and reception sensitivity that have been set/determined at S209 and S210 together with the MAC address that identifies the communication device 100-2, completes setting of the communication distance in the near-field communication mode (S211), and then the process returns to S202.

Programs executed in the communication device according to the present embodiment are provided with being prebuilt in a ROM and the like. The programs executed in the communication device in the present embodiment may be provided in a manner in which they are recorded as files in an installable or executable format in a recording media, such as a CD-ROM, a flexible disc (FD), a CD-R, or a digital versatile disc (DVD), that is readable by a computer.

The programs executed in the communication device in the present embodiment may be provided in a manner in which they are stored in a computer connected to a network such as the Internet, and are downloaded via the network. The programs executed in the device in the present embodiment may also be provided or distributed via a network such as the Internet.

The programs executed in the communication device in the present embodiment are configured as a module that comprises the above described functional configuration. The hardware for the programs is configured such that a CPU (processor) reads the programs from the ROM and executes them, so that the functional configuration described above is loaded and generated on a main memory.

The above described embodiment is not intended to limit the scope of the invention. Indeed, the embodiment described herein can be embodied by making modifications to the constituent elements without departing from the spirit of the invention. The embodiment described herein can be embodied in a variety of other forms by combining as appropriate a plurality of constituent elements described in the above embodiment. For example, some constituent elements may be omitted from the entire constituent elements described in the embodiment. Furthermore, constituent elements indifferent embodiments may be combined as appropriate.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a single communication module configured to operate in a first mode or a second mode, the first mode corresponding to near-field wireless communication, the second mode corresponding to wireless communication configured to be performed in a longer communication distance than a communication distance at which the near-field wireless communication is performed; and
a controller configured to cause the communication device to intermittently perform wireless transmission or reception in the first mode or in the second mode, to cause the communication device to intermittently perform wireless reception in the second mode at a period based on information repeatedly informed by an external device at a predetermined period, and to cause the communication device to intermittently perform, while being synchronized with an operation timing of the second mode, wireless transmission or reception in the first mode during when wireless reception in the second mode is not performed.

2. The communication device of claim 1, wherein
the external device is an access point configured to perform wireless communication with a plurality of communication devices; and
the information is a beacon signal notified with respect to the communication devices by the access point.

3. The communication device of claim 2, wherein the controller is configured to correct, based on the beacon signal, a period at which the second communication mode is performed.

4. The communication device of claim 2, wherein the period at which the second communication mode is performed is obtained by an integral multiple of a period of the beacon signal.

5. The communication device of claim 1, wherein, upon receipt of the information at the time of the wireless reception in the second communication mode, the communication module is configured not to transmit a response signal in response to the informed signal.

6. The communication device of claim 1, wherein the communication module is configured to establish near-field wireless communication with an external device with which wireless communication in the first communication mode has been performed at least twice.

7. The communication device of claim 1, wherein
the information comprises first identification information configured to identify the external device; and
the controller is configured to cause the communication device to intermittently perform wireless transmission or reception in the first communication mode when the information comprises the first identification information configured to identify a predetermined external device.

8. The communication device of claim 1, further comprising an operation module configured to receive an operation instruction by a user, wherein
the controller is configured to set, based on the operation instruction by the user, transmission output or reception sensitivity used in performing near-field wireless communication in the first communication mode.

9. The communication device of claim 8, wherein, when the operation instruction is made by the user, the controller is configured to increase transmission output of the communication device while maintaining reception sensitivity of an external device configured to perform near-field wireless communication in the first communication mode in a predetermined state, and to set a lowest value of the transmission output with which the communication device performs transmission to which the external device responds.

10. The communication device of claim 8, wherein, when the operation instruction is made by the user, the controller is configured to increase reception sensitivity of the communication device while maintaining transmission output of an external device configured to perform near-field wireless communication in the first communication mode in a predetermined state, and to set a lowest value of the reception sensitivity with which the communication device receives transmission from the external device.

11. The communication device of claim 8, further comprising a storage module configured to store therein the set transmission output or the set reception sensitivity and second identification information configured to identify the set external device, in association with each other, wherein,
when performing near-field wireless communication with an external device in the first communication mode, the controller is configured to set the transmission output or the reception sensitivity stored in association with the second identification information of the external device.

12. The communication device of claim 8, wherein
the storage module is configured to store therein the second identification information and a parameter used in establishing near-field wireless communication with an external device identified by the second identification information, and,
when performing near-field wireless communication with the external device in the first communication mode, the controller is configured to establish communication based on the parameter stored in association with the second identification information of the external device.

13. A communication method of a communication device, the communication device comprising a single communication module configured to operate in a first mode or a second mode, the first mode corresponding to near-field wireless communication, the second mode corresponding to wireless communication configured to be performed in a longer communication distance than a communication distance at which the near-field wireless communication is performed, the method comprising:
causing, by a controller, the communication device to intermittently perform wireless transmission or reception in the first mode or the second mode;
causing, by the controller, the communication device to perform wireless reception in the second mode at a period based on information repeatedly informed by an external device at a predetermined period; and
causing, by the controller, the communication device to intermittently perform, while being synchronized with an operation timing in the second mode, wireless transmission or reception in the first mode during when wireless reception in the second mode is not performed.
